(19) United States
(12) Patent Application Publication
(10) Pub. No.: US 2017/0320519 A1
(43) Pub. Date: Nov. 9, 2017

(54) METHOD FOR SUPPORTING A DRIVER DURING THE MONITORING OF DRIVING OF A MOTOR VEHICLE OR OF A MOTOR VEHICLE-TRAILER COMBINATION

(71) Applicant: Robert Bosch Automotive Steering GmbH, Schwäbisch Gmünd (DE)

(72) Inventor: Nicolas Boos, Mutlangen (DE)

(21) Appl. No.: 15/319,519

(22) PCT Filed: Apr. 8, 2015
(86) PCT No.: PCT/EP2015/057543

§ 371 Date: Dec. 16, 2016

(30) Foreign Application Priority Data
Jun. 17, 2014 (DE) 10 2014 108 489.6

(51) Int. Cl. B62D 13/06; B62D 13/00; B62D 15/02

(52) U.S. Cl. CPC B62D 13/06; B62D 15/027; B62D 13/00; B60T 2230/08

(57) ABSTRACT

Method for supporting a driver by monitoring driving of a motor vehicle or a motor vehicle with trailer comprising a towing motor vehicle and at least one trailer coupled thereto, comprising at least the following steps: detection of image signals of a surroundings area of the motor vehicle or of the motor vehicle with trailer by at least two cameras arranged in particular on the motor vehicle or on the motor vehicle with trailer; transmission of the detected image signals of the cameras to at least one display device; display on the display device of one or more camera images based on transmitted image signals of the camera, wherein the camera images to be displayed are selected depending on the relative position and/or orientation of the driver to the motor vehicle or to the motor vehicle with trailer and/or depending on a number of driving state variables of the motor vehicle or the motor vehicle with trailer.

### BACKGROUND OF THE INVENTION

The invention relates to a method for supporting a driver during the monitoring of the driving of a motor vehicle or of a motor vehicle-trailer combination.

There are a large number of methods for supporting the driver during the maneuvering of a motor vehicle with or without a trailer. In some methods, the driver's viewing field is extended by cameras. Other methods permit remote control of the vehicle from the outside so that the driver can obtain a better overview than would be possible from the driver's seat.

In US 2001026317 A and U.S. Pat. No. 7,295,227 B the driver of a vehicle is supported during the maneuvering in that the trajectory of the vehicle is displayed in a way which matches the selected steering wheel angle in a camera image of the area to the rear.

In EP 2 295 281 A1, the driver is supported during the monitoring of an autonomous parking process by image data from cameras being displayed on a remote-control system. The cameras are selected by virtue of the fact that the position of the remote-control system relative to the motor vehicle is determined and the images of the cameras are displayed on the side facing away from the remote-control device.

In large vehicles such as e.g. trucks or construction machinery, the driver cannot obtain an overview of the entire surroundings of the vehicle from an individual position inside or outside the vehicle. This applies, in particular, to vehicles which are composed of a plurality of hitched-together vehicle parts, but can also apply to relatively small vehicles such as passenger cars. However, for the precise and collision-free maneuvering of the vehicle it is desirable that the driver can obtain an overview of the currently relevant areas of the surroundings.

If the vehicle is equipped only with one camera, this camera covers only a small area of the surroundings. If the vehicle is equipped with a plurality of cameras, the driver must switch the cameras manually and therefore cannot concentrate fully on the driving task. If a plurality of camera images are displayed at the same time, the assignment of the represented camera images to the positions and fields of vision of the individual cameras is made more difficult, as a result of which the driver is distracted further from his driving task. If the driver performs remote control of the vehicle from the outside, he must travel large distances in order to obtain a complete overview.

Therefore, a method is sought which permits the driver to obtain a complete overview of the relevant areas of the surroundings of the vehicle in virtually any position inside and outside the vehicle, without in the process being distracted from his driving task and/or having to leave his position.

### SUMMARY OF THE INVENTION

In the method which is presented, the vehicle or the vehicle-trailer combination is equipped with at least two cameras. A mobile or permanently installed display apparatus (e.g. a monitor or a touch screen device) displays one or more camera images, preferably simultaneously. Depending on the relative position and orientation of the operator or of the driver with respect to the vehicle or the vehicle-trailer combination and on driving state variables of the vehicle or vehicle-trailer combination it is possible to display automatically the camera images which permit, in conjunction with the driver's own field of vision, an optimum overview of the relevant areas of the surroundings. In order to facilitate the assignment of the displayed camera image or displayed camera images to the position and field of vision of the cameras, the vehicle or the vehicle-trailer combination can optionally be represented from a bird's eye view on the display apparatus, and the camera images can be included in the display at the correct position and with the correct orientation.

The relevant areas of the surroundings of the vehicle or of the vehicle-trailer combination can be determined by taking into account of a dependency on the driving state variables.

The relevant areas of the surroundings can be here, in particular, the areas into which the vehicle or parts of the vehicle are moving at that moment. In the case of reverse travel of a vehicle-trailer combination this can be e.g. the area behind the trailer or the lateral area into which the towing vehicle pivots.

Driving state variables for the determination of the relevant areas of the vehicle or the vehicle-trailer combination can be, inter alia, wheel steering angles of the steered axles, wheel speeds or vehicle velocities of the hitched-together vehicle parts, bending angles of the hitched-together vehicle parts with respect to one another and/or angles and positions of vehicle bodies.

The relative position and orientation of the driver with respect to the vehicle can be determined e.g. by means of GPS, BLE, image recognition or some other method which is suitable for determining the relative position and orientation of two objects with respect to one another.

The driver's field of vision can be determined or estimated by means of the relative position and orientation of the driver and the orientation of the display apparatus or can be determined by means of methods for detecting a field of vision such as e.g. eye tracking.

Objects or obstacles which have been detected in the camera images by means of an additional surroundings sensor system or by means of an image recognition system can optionally be highlighted in the camera images and the driver can be warned by means of further visual, acoustic and/or haptic signals. The recognition of obstacles can also optionally be used to switch over the camera images.

The driver can optionally override the automatic selection of the cameras by switching the display of individual cameras on or off by tapping the camera symbol on the display apparatus or the touch screen device.

The driver can optionally enlarge individual camera images by tapping on the camera image to be enlarged on the touch screen device or by selecting the camera image to be enlarged in some other way on the display apparatus.

### BRIEF DESCRIPTION OF THE DRAWINGS

Variants of the functional principle of the method and exemplary embodiments of the invention are explained by way of example and in accordance with the principle with reference to the figures.

Reference is made below to motor vehicle-trailer combinations. The invention can, however, also be used in individual motor vehicles without a trailer. Functionally identical elements with the same reference symbols are provided in the figures.

In the drawings:

FIGS. 1 to 5 show schematic illustrations of a vehicle-trailer combination;

FIG. 6 shows a schematic plan view of a vehicle-trailer combination; and

FIG. 7 shows a schematic illustration of a detail of a display device.

### DETAILED DESCRIPTION

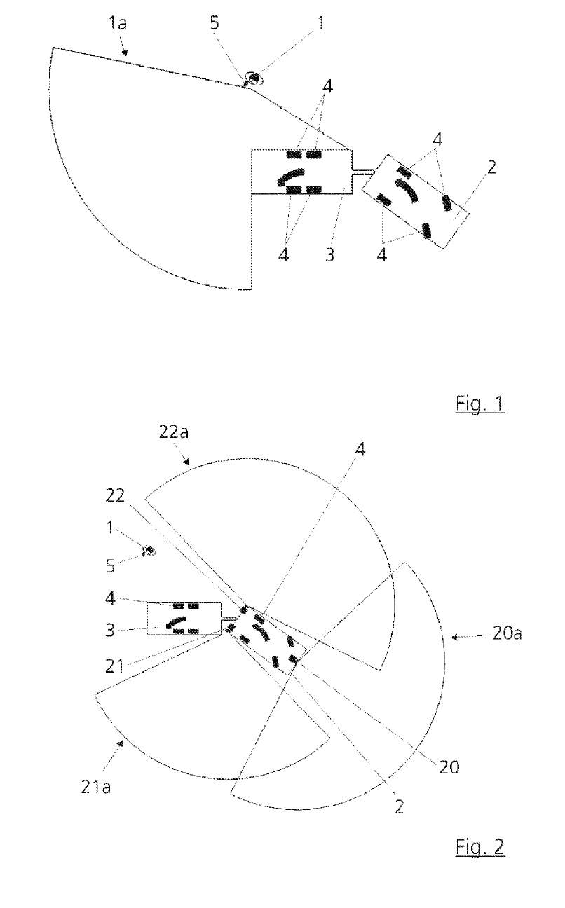

FIG. 1 shows the position and the field of vision 1a of an operator 1 and the direction of movement (indicated by arrows in FIGS. 1 to 5) of the vehicle parts of a vehicle-trailer combination comprising a towing vehicle 2 and a trailer 3 which is coupled thereto. The wheels of the vehicle-trailer combination are provided with the reference symbol 4. The operator 1 can use e.g. a remote-control device or remote-control apparatus 5 (illustrated in highly simplified fashion) for the vehicle-trailer combination, said system or apparatus 5 having a display device on which the camera images to be selected can be displayed.

FIG. 2 illustrates by way of example various positions of cameras 20, 21, 22 on the towing vehicle, and the associated fields of vision 20a, 21a, 22a of the cameras 20, 21, 22.

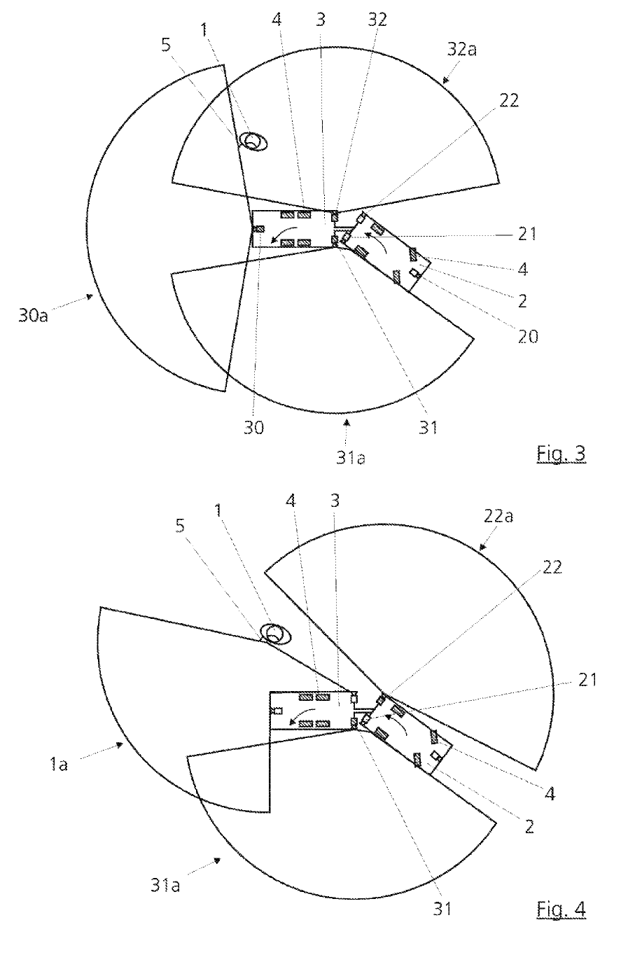

FIG. 3 shows by way of example various positions of cameras 30, 31, 32 on the trailer 3, and the associated fields of vision 30a, 31a, 32a of the cameras 30, 31, 32.

The cameras which are selected by the method according to the invention and whose images are to be displayed on the display device are provided with hatching in FIGS. 4 and 5.

In FIG. 4, two cameras 22, 31 are highlighted with their associated fields of vision 22a, 31a which have been selected by the method according to the invention. In the present example, the method according to the invention has selected the right-hand camera 31 located on the trailer 3, since the operator 1 is standing on the left-hand side of the vehicle, and the camera 21 on the right of the towing vehicle 2 has a field of vision which is partially concealed by the trailer 3 (not illustrated in FIG. 4)—the position of the operator 1 and the bending angle of the vehicle-trailer combination are significant here. Furthermore, the method selects the camera 22 on the left of the towing vehicle 2, since the operator 1 is looking backward and the towing vehicle 2 is swinging to the left, and the camera 22 on the left of the towing vehicle 2 has a field of vision which is partially concealed by the towing vehicle 2 (the field of vision 1a of the operator 1, the direction of movement and the bending angle of the vehicle-trailer combination are significant here).

FIG. 5 illustrates three fields of vision 20a, 22a, 31a of three cameras 20, 22, 31 which have been selected using the method according to the invention. In the present example, the respective cameras 20, 22, 31 are selected for the following reasons: the method selects the camera 31 on the right of the trailer 3, since the driver 1 is standing on the left-hand side of the vehicle, and the camera 21 on the right of the towing vehicle 2 has a field of vision which is partially concealed by the trailer 3 (the position of the operator 1 and the bending angle of the vehicle-trailer combination are significant here). The method selects the camera 22 on the left of the towing vehicle 2, since the operator 1 is looking backward and the towing vehicle 2 swings to the left, and the camera 22 on the left of the towing vehicle 2 has a field of vision which is partially concealed by the towing vehicle 2 (the field of vision 1a of the operator 1, the direction of movement of the towing vehicle and the bending angle of the vehicle-trailer combination are significant here). The method selects the camera 20 on the front of the towing vehicle 2, since the operator 1 is standing at the rear of the trailer 3 and is looking backward (the position and the field of vision 1a of the operator 1 are significant here).

The inventor has found that the number of relevant possibilities of camera combinations—even in relatively large vehicle-trailer combinations—can be reduced significantly if the driving state variables are taken into account in the selection.

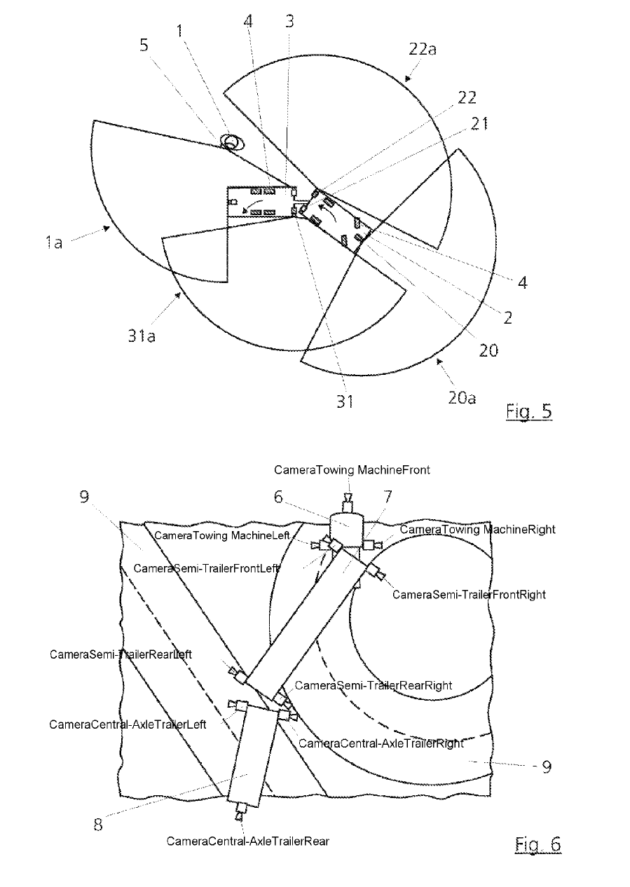

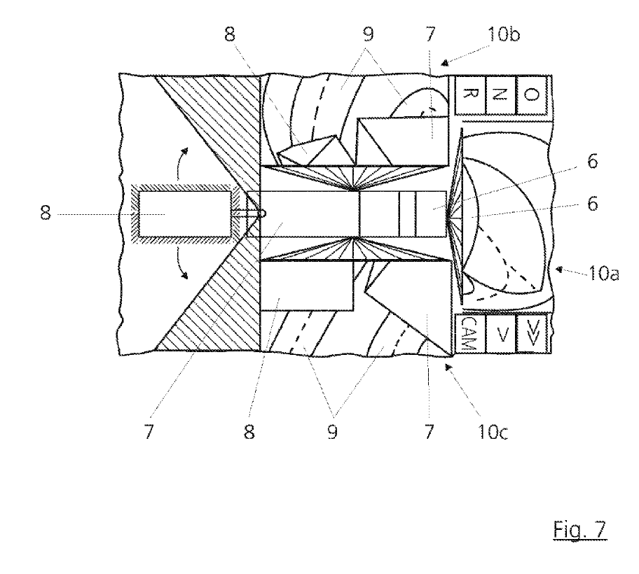

FIGS. 6 and 7 illustrate a further embodiment of the method according to the invention.

FIG. 6 is a schematic illustration of a plan view of a vehicle-trailer combination comprising a towing machine 6, a semi-trailer 7 and a central-axle trailer 8 with associated cameras on a lane 9.

The following algorithm is a possible variant for the vehicle-trailer combination with three vehicle parts and 10 cameras from FIG. 6. The algorithm switches not only between the cameras but also determines the display on the display apparatus. Bending angles are by definition positive if the vehicle is driving through a left-hand bend. In FIG. 6, the front bending angle would accordingly be positive and the rear one would be negative (not illustrated).

IF position == LeftOfVehicle-TrailerCombination THEN
IF DirectionOfTravel = Forward THEN
ScreenLayout =
Camera1Top_Camera2RightCenter_Camera3RightBottom
Camera1 = CameraTowingMachineFront
OTHERWISE
ScreenLayout =
Camera1Bottom_Camera2RightCenter_Camera3RightBottom
Camera1 = CameraCentral-AxleTrailerRear
IF_END
IF BendingAngleSemi-Trailer >= 0 THEN
Camera2 = CameraSemi-TrailerFrontRight
OTHERWISE
Camera2 = CameraTowingMachineRight
IF_END
IF BendingAngleCentral-AxleTrailer >= 0 THEN
Camera3 = CameraSemi-TrailerRearRight
OTHERWISE
Camera3 = CameraCentral-AxleTrailerRight
IF_END
OTHERWISE_IF Position == RightOfVehicle-TrailerCombination THEN
IF DirectionOfTravel = Forward THEN
ScreenLayout =
Camera1Top_Camera2CenterLeft_Camera3BottomLeft
Camera1 = CameraTowingMachineFront
OTHERWISE
ScreenLayout =
Camera1Bottom_Camera2CenterLeft_Camera3BottomLeft
Camera1 = CameraCentral-AxleTrailerRear
IF_END
IF BendingAngleSemi-Trailer >= 0 THEN
Camera2 = CameraTowingMachineLeft
OTHERWISE
Camera2 = CameraSemi-TrailerFrontLeft
IF_END
IF BendingAngleCentral-AxleTrailer >= 0 THEN
Camera3 = CameraCentral-AxleTrailerLeft
OTHERWISE
Camera3 = CameraSemi-TrailerRearLeft
IF_END
OTHERWISE_IF Position == InFrontOfVehicle-TrailerCombination
THEN
ScreenLayout = Camera1Bottom_Camera2Left_Camera3Right
Camera1 = CameraCentral-AxleTrailerRear
IF BendingAngleCentral-AxleTrailer >= 0 THEN
Camera2 = CameraCentral-AxleTrailerLeft
Camera3 = CameraSemi-TrailerRearRight
OTHERWISE
Camera2 = CameraSemi-TrailerRearLeft
Camera3 = CameraCentral-AxleTrailerRight
IF_END
OTHERWISE_IF Position == ToRearOfVehicle-TrailerCombination
THEN
ScreenLayout = Screen1Top_Camera2Left_Camera3Right
Camera1 = CameraTowingMachineFront
IF BendingAngleSemi-Trailer >= 0 THEN
Camera2 = CameraSemi-TrailerFrontLeft
Camera3 = CameraTowingMachineRight
OTHERWISE
Camera2 = CameraTowingMachineLeft
Camera3 = CameraSemi-TrailerFrontRight
IF_END
OTHERWISE_IF

FIG. 7 illustrates by way of example a schematic image of a display device. The vehicle or the vehicle-trailer combination with the vehicle parts 6, 7 and 8 are shown from a bird's eye view on the display device. Camera images 10a, 10b and 10c which are selected by the method according to the invention are indicated in simplified form. The camera images 10a, 10b and 10c are displayed relative to the depicted vehicle-trailer combination according to the arrangement of the cameras on the vehicle-trailer combination.

1. A method for supporting a driver during the monitoring of the driving of a motor vehicle or of a motor vehicle-trailer combination comprising a towing vehicle and at least one trailer which is coupled thereto, the method comprising:
detecting image signals of a surrounding area of the motor vehicle or of the motor vehicle-trailer combination by means of at least two cameras which are arranged on the motor vehicle or on the motor vehicle-trailer combination;
transmitting the detected image signals of the cameras to a display device; and
displaying one or more camera images, based on the transferred image signals of the cameras, on the display device, wherein the camera images to be displayed are selected as a function of the relative position, the relative orientation, or both the relative position and the relative orientation of the driver with respect to the motor vehicle or with respect to the motor vehicle-trailer combination, as a function of a number of driving state variables of the motor vehicle or of the motor vehicle-trailer combination, or a combination of the foregoing.

2. The method as claimed in claim 1, wherein the camera images are selected of those cameras which, in conjunction with the field of vision of the driver, permit an optimum overview of the parts of the surrounding area of the motor vehicle or of the motor vehicle-trailer combination which are relevant for the monitoring.

3. The method as claimed in claim 1, wherein the driving state variables comprise a wheel steering angle of the motor vehicle or of the motor vehicle-trailer combination, a velocity, one or more wheel speeds, one or more bending angles between vehicles of the motor vehicle-trailer combination, positions or orientations of vehicle bodies of the motor vehicle or of the motor vehicle-trailer combination, or a combination of the foregoing.

4. The method as claimed in claim 1, wherein the driving of the motor vehicle or of the motor vehicle-trailer combination is implemented automatically by a control device of the motor vehicle or of the motor vehicle-trailer combination by means of electronic actuation of a drive device and of a steering device of the motor vehicle or of the towing vehicle.

5. The method as claimed in claim 1, wherein a remote-control device comprises the display device.
